(19) United States
(12) Patent Application Publication
(10) Pub. No.: US 2023/0416004 A1
(43) Pub. Date: Dec. 28, 2023

(54) NON-STICK BELT WITH IMPROVED ADHESION, PUNCTURE, CONFORMABILITY AND FLEX PROPERTIES

(71) Applicant: AFC SPECIALTY COATINGS GROUP, INC., LAKE IN THE HILLS, IL (US)

(72) Inventors: William Christopher Lewis, Saint Charles, IL (US); Barton R. LEWIS, Algonquin |, IL (US); Malcolm SWIFT, Lake In The Hills, IL (US); William James LEWIS, Naples, FL (US); Ismael SALOMON, Dallas, GA (US)

(73) Assignee: AFC SPECIALTY COATINGS GROUP, INC., LAKE IN THE HILLS, IL (US)

(21) Appl. No.: 18/039,413

(22) PCT Filed: Dec. 3, 2021
(86) PCT No.: PCT/US2021/061825

§ 371 Date: May 30, 2023

Related U.S. Application Data
(60) Provisional application No. 63/121,092, filed on Dec. 3, 2020.

(51) Int. Cl. B65G 15/34; B30B 5/04

(52) U.S. Cl. CPC B65G 15/34; B30B 5/04

(57) ABSTRACT

A flexible nonstick material for use in belting and/or press operations, such as for dough pressing or plastic sheet welding/cutting. The material comprises a nonstick polymer coated flexible substrate having a thickness of 15 mils or less, wherein the flexible substrate comprises a woven yarn fabric having a basket weave or a satin weave. The woven yarn fabric comprises yarns of fiberglass and/or high temperature resistant polymer materials. The nonstick coating is a fluoropolymer, a silicone rubber, and/or a thermoplastic having a sufficient heat resistance.

### CROSS REFERENCE TO RELATED APPLICATION(S)

This application claims the benefit of and priority to U.S. Patent Application Ser. No. 63/121,092, filed on 3 Dec. 2020. The co-pending application is hereby incorporated by reference herein in its entirety and is made a part hereof, including but not limited to those portions which specifically appear hereinafter.

### FIELD OF THE INVENTION

This invention relates generally to conveyor belts and other non-stick applications, and, more particularly, to improved materials for such non-stick belts and other applications.

### BACKGROUND OF THE INVENTION

Conveyor belts are known for a variety of uses, such as in food preparation or cooking applications, where the belt is used to convey objects continuously through a processing unit and/or or a cooking or heating zone of high temperatures. Silicone rubber-coated fiberglass fabrics and polytetrafluoroethylene (“PTFE”) coated and/or laminated fiberglass fabrics, are commonly used in conveyor belts for diverse applications, as well as various cookware applications.

Various weaves are known in the fabric and belting industries. Plain weaves are the standard used for lightweight belting (e.g., under 20 mils), due to historical use and lower cost. In a plain weave, each warp fiber passes alternately under and over each weft fiber. The fabric is symmetrical, with good stability and reasonable porosity. With large fibers, plain weave style can result in excessive crimp and therefore it tends not to be used for heavy fabrics.

Satin weaves are known and used for heavy weight belting, such as those over 20 mils in thickness. Satin weaves can allow fibers to be woven in a close proximity and can produce fabrics with a ‘tight’ weave. The weave is known to have a low stability and its asymmetry can cause one face of the fabric to have fiber running predominantly in the warp direction while the other face has fiber running predominantly in the weft direction. These concerns can be lessened in heavier fabrics.

Basket weave is another weave known for heavier fabrics. Basket weave can be flatter and stronger than a plain weave due to less crimp, but is less stable. Basket weave is used on heavy weight fabrics made with thick (high tex) fibers to avoid excessive crimping.

There is a continuing need for improved non-stick belting and other processing/manufacturing applications.

### SUMMARY OF THE INVENTION

A general object of the invention is to provide an improved material particularly, but without limitation, for use in the lightweight belting, pressing, and plastic welding categories. As used herein, “belt” refers to not only continuous or endless belts, but also planar and/or non-traveling materials, such as elongated material held between two rigid points, or a wrapped material, such as wrapped around a roller or equivalent.

A general object of the invention can be attained, at least in part, through a flexible nonstick material or belt, such as for use in press operations, including a nonstick polymer coated flexible substrate having a thickness of 15 mils or less. The flexible substrate is formed of a woven yarn fabric having a basket weave or a satin weave.

The invention further includes a flexible nonstick material or belt of a nonstick polymer coated flexible substrate having a thickness of 15 mils or less. The flexible substrate is formed of a woven yarn fabric with at least a 2×2 basket weave or a 4 to 8 harness satin weave.

The invention further includes a flexible nonstick material or belt, such as for use in press operations, of a nonstick polymer coated flexible substrate having a thickness of 15 mils or less. The flexible substrate is formed of a woven yarn fabric having a conformable weave that is not a plain or twill weave, such as, without limitation, a conformable balanced weave (e.g., a basket weave) or a conformable non-balanced weave (e.g., a satin weave).

The woven yarn fabric of this invention can be formed of yarns of fiberglass and/or a polymer material such as aramid, polyimide, polyphenylene sulfide, polyethersulfone, and polyetheretherketone, or combinations thereof.

In embodiments of this invention, the woven yarn fabric includes two or more warp fibers alternately interlaced with two or more weft fibers.

In embodiments of this invention, the woven yarn fabric includes fibers extending in one direction over at least three of a plurality of fibers extending in a second (e.g., perpendicular) direction before passing under one of the plurality of fibers extending in the second direction.

In embodiments of this invention, the woven yarn fabric includes at least a 2×2 basket weave, more preferably a 3×3, 4×4, etc., or an asymmetrical basket pattern.

In embodiments of this invention, the woven yarn fabric includes a 4-8 harness satin weave. In embodiments of this invention, a thicker polymer coating is used on a rough side of the satin weave than on a smooth side.

In embodiments of this invention, the nonstick polymer is a coating of a fluoropolymer, such as a fluoroplastic, preferably polytetrafluoroethylene (PTFE), or a fluoroelastomer, a silicone rubber, a thermoplastic having a high heat resistance (over 350° F. (177° C.)), or combinations thereof.

In other embodiments of the invention the material can be affixed to processing surface, such as a welding surface, using an adhesive on one side (e.g., opposite the non-stick side) of the material/belt. Any suitable adhesive material can be used.

In embodiments of this invention, the material/belt is a continuous conveyor belt or a tensioned press platen.

In embodiments of this invention, the press operations are selected from food pressing or plastic welding, and the flexible nonstick material or belt supports an object to be pressed, such as a dough ball or two or more overlaid plastic sheets.

The invention includes a use of any embodiment of the flexible nonstick material or belt in a press operation. Exemplary press operations include a dough press or a plastic welding press.

The invention further includes a method of using any of the flexible nonstick materials or belts of this invention. In embodiments of this invention, the method includes providing the flexible nonstick material/belt under a press platen, providing an object to be pressed on the flexible nonstick material/belt and under the press platen, and pressing the object on the flexible nonstick material/belt with the press platen.

In embodiments of this invention, the material has a normalized puncture resistance (puncture/thickness) of over 5000, more desirably 5100, and preferably over 5300.

Other objects and advantages will be apparent to those skilled in the art from the following detailed description taken in conjunction with the appended claims and drawings.

### BRIEF DESCRIPTION OF THE DRAWINGS

FIGS. 1 and 2 show a belt according to one embodiment of this invention.

FIG. 3 shows a basket fabric weave according to one embodiment of this invention.

FIG. 4 shows a satin fabric weave according to one embodiment of this invention.

FIG. 5 shows a crowsfoot fabric weave according to one embodiment of this invention.

FIG. 6 representatively illustrates a press operation according to one embodiment of this invention.

FIG. 7 representatively illustrates a press operation according to one embodiment of this invention.

FIGS. 8-11 each show a belt material according to illustrated examples.

FIGS. 12A and 12B include a table showing testing results comparing a material of this invention to other commercial belt materials.

### DESCRIPTION OF EMBODIMENTS OF THE INVENTION

The present invention is directed to improved materials such as for use in the lightweight belting (e.g., ≤15 mils thickness) in the food processing and plastic welding categories. Embodiments of this invention incorporate non-standard weaves with non-stick materials that result in unexpected improvements in longevity, such as improved adhesion resistance, puncture resistance, dimensional stability (resistance to bagging), tear resistance, and tensile resistance, as well as desirable or improved conformability and flex properties.

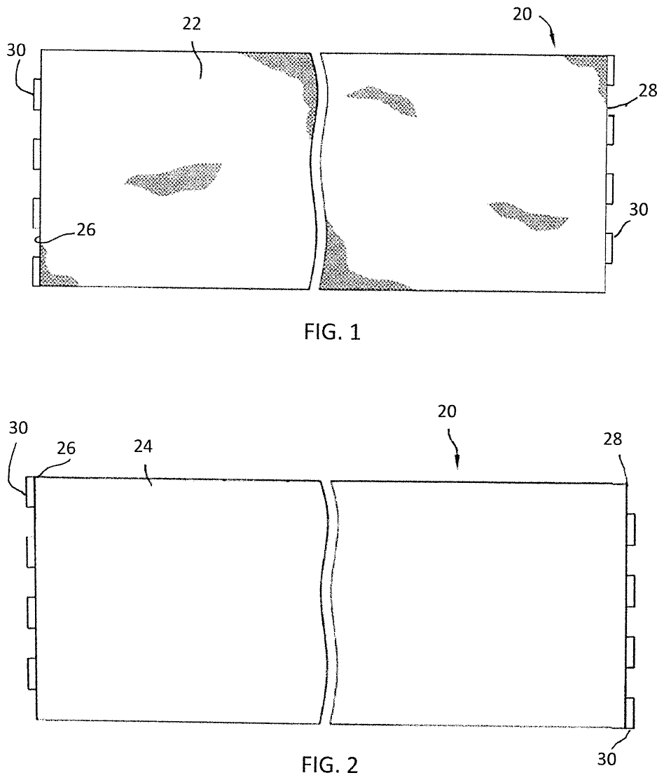

Embodiments of this invention include a flexible material for a continuous conveyor belt or other non-stick application, which includes a flexible substrate having a first face and a second face opposite the first face, and a coating on at least the first face of the flexible substrate. FIGS. 1 and 2 shows a representative endless belt 20, formed of a flexible substrate having a coated first surface 22, and an uncoated or coated second surface 24. When formed into a continuous belt, the material of this invention can be attached at opposing ends 26 and 28 by any suitable splicing 30, with an additional support material band if needed. Splicing examples include, without limitation, non-metallic soft sealed lacings (e.g., with a metallic or non-metallic pin), loop lacings, finger lacings, overlay lacings, or metallic splice (e.g., alligator) lacings.

The flexible substrate can be formed of, for example, fiberglass, aramid, polyimide, polyphenylene sulfide, polyethersulfone, polyetheretherketone (PEEK), or combinations thereof. In embodiments of this invention the flexible substrate is formed of yarns of, or including E-Glass, S-Glass, C-Glass, quartz, ECR-Glass, basalt, or combinations or blends thereof. The flexible substrate desirably includes a woven yarn fabric of these materials, the substrate fabric having a thickness (uncoated) of under 13 mils, such as 11 or 12 mils, or such as about 3 mils to about 8-10 mils, desirably about 5 mils to 8 mils.

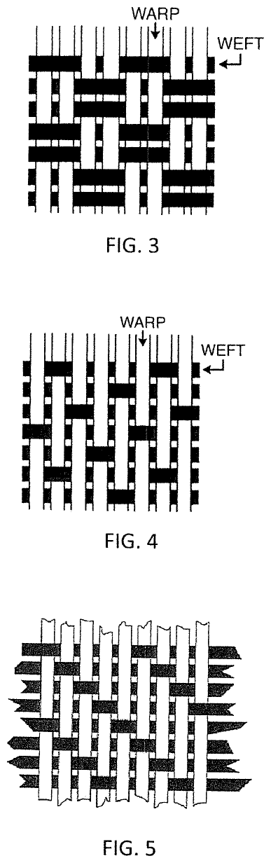

The flexible substrate of embodiments of this invention includes a basket, crowsfoot, or satin weave, or any other conformable weave. A representative basket weave is shown in FIG. 3, and includes two or more warp fibers alternately interlaced with two or more weft fibers. An arrangement of two warps crossing two wefts is designated a 2×2 basket, but 3×3 or 4×4 baskets or greater can be used, and the arrangement of fibers need not be symmetrical (e.g., 4×2, 5×4, etc.).

A representative satin weave is shown in FIG. 4 and includes a ‘floating’ warp or weft yarn over four or more of the other of the warp or weft yarns. The floating yarn is then passed under one of the other yarn before repeating the process again. Satin weaves produce fewer intersections of warp and weft. The ‘harness’ number used in the designation is the total number of fibers crossed and passed under, before the fibers repeat the pattern. Embodiments of this invention include a 4 to 8 harness satin weave, and desirably a 4 or 8 harness satin weave. Desirable embodiments of this invention further include a flexible substrate with a crowsfoot weave, which is a form of satin weave with a different stagger in the repeat pattern, such as shown in FIG. 5.

Satin weave fabrics have a face and a back that look significantly different from each other, due to the harness crossings on one side. The weft yarns are predominant on the face of the cloth, and the warp yarns that bind the weft floats should be scattered as widely as possible. Satin-woven fabrics are strong due to the high number of yarns used, yet fewer interlacings provide pliability and resistance. Satin weaves tend to have a smooth weft side and a “rough” warp side. The rough side in embodiments of this invention receives a thicker polymer coating than the opposing side.

The flexible coating is coated on at least a first side, and desirably both sides of the substrate, with one or more coating materials that imparts a non-stick surface. The coating can be or include a fluoropolymer, such as a fluoroplastic (e.g., PTFE) or a fluoroelastomer, a silicone rubber, a thermoplastic having a suitable temperature rating for the intended use (such as heat resistance over 350° F.), or combinations thereof. The coating can be applied by any of various methods known in the industry, such as spray, knife over roll or dip coating. Once coated, the materials of this invention have a total thickness of under 20 mils, and more desirably under 15 mils, such as about 5 mils to about 15 mils, and desirably about 5 mils to about 10 mils.

It has been discovered that coating the particular weaves according to this invention provides significantly improved durability (puncture, tear, dimensional stability (resistance to bagging), and grease/oil resistance), thus providing measurable improvement in product life for desirable lightweight belting applications. The non-stick coated fabric materials of this invention can be used in any of numerous non-stick applications, such as in food processing (e.g., contact belt grilling, pressing of tortillas, flat breads, and pizza crust, and cooking/baking belting), high speed plastic welding (e.g., mylar balloon manufacture, plastic bag making, side sealing, form-fill-seal, overwrapping, high-speed sealing, and bag closure application (plastic bags)), bun toasting, processing of rubber, foam, or plastics (e.g., calendaring, pressing, and extrusion), textiles (e.g., nonwoven manufacture), manufacturing of vinyl windows, mylar balloons, plastic bags, etc., or other plastic processing.

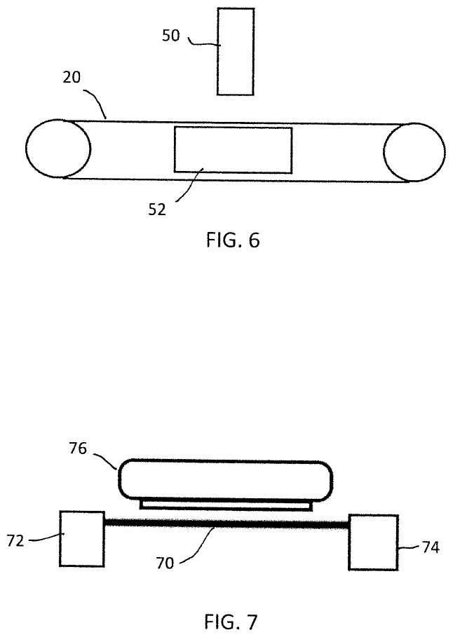

FIG. 6 illustrates a representative press operation, where a belt 20 passes between two press platens 50, 52. As an example, dough balls are moved on belt 20 until under upper platen 50. The platen 50 then descends to press the dough ball into the desired flattened shape, for example, a tortilla. The belt materials of this invention have been discovered to be more suitable for such press operations over weaves with more yarn intersections (e.g., a plain weave). The belts of this invention are more forgiving to any hard particles in the dough (e.g., seeds, carbonization, etc.) and thus more puncture resistant. In addition, the belts of this invention are less likely to experience sag in the puncture area, which causes the belt to slip if not tightened, and to break/tear when further tightened to reduce slipping.

FIG. 7 illustrates a second press operation, from an upstream end view, such as for plastic welding operations. Here the plastic material moves over a fixed material/belt 70 of this invention, which is tensioned between two end holders 72, 74. Rolls of plastic are unrolled over the material/belt 70, and the cutting and/or welding head 76 is lowered against the layers of plastic on the material/belt 70. Again, the lightweight material of this invention is more forgiving/recoverable against the pressing head 76, providing more durability against sags and/or tears, and a longer lifetime.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

Belts according to embodiments of this invention were tested in tortilla processing applications, and compared to a current commercial belt being used for this process. In general, the market looks for belting that can be used with various food products, and is resistant to grease/oil penetration, tears, or holes. The tortilla industry further seeks good heat transfer for new products that are being processed in this market (e.g., low fat, high water content), where lower temps at the platen will allow for better tortilla quality. This will also address “vaporization” (excessive loss of water when pressing dough). Flexibility is important, as it resists puncturing and tearing particularly for tortillas made of whole grains, seeds, or other abrasive fillers/additives.

In a first example, an 8 mil coated belt according to this invention, having a 4 harness satin weave fiberglass substrate and PTFE coating was tested against the current 7 mil (total thickness), 2-ply laminate belt in commercial use. The new coated belt performed thermally equivalent to the current belt on a Lawrence 42 press. The test belt had no holes after two weeks, while the commercial laminate belt developed holes within one day.

In another test, the new belt ran for three weeks and consistently averaged a 97-98% efficiency vs. the control belt's 93-95%, thus reducing waste. The belt was removed for process maintenance and the testing concluded, but by making a minor repair on the seam the test belt could have run longer. The belt was run at 290° F. for top platen and 310° F. for the bottom. The belt developed only a few small holes and there was no need to apply any patches during the run time. No signs of oil ingress or delamination were seen.

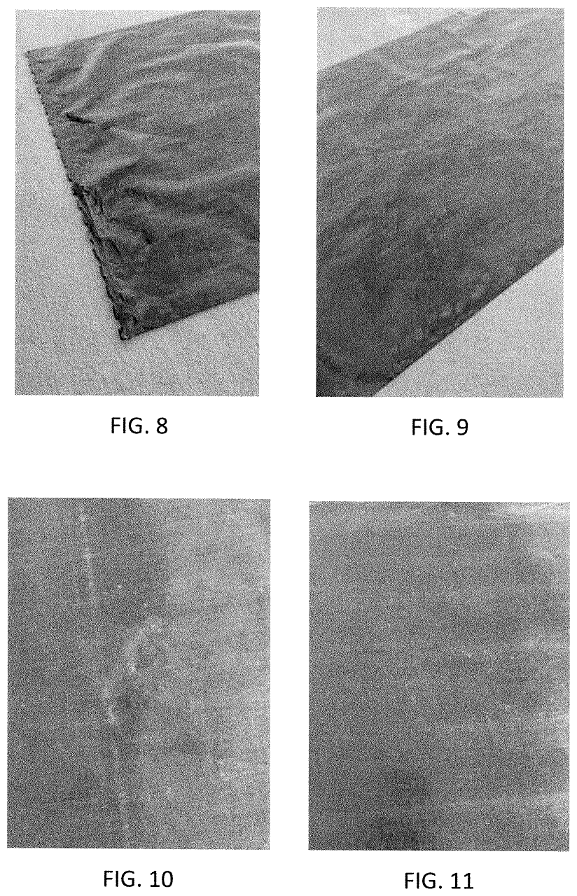

The tortilla testing demonstrated that the belts of this invention had significantly improved puncture resistance, improved heat transfer, and significant improvement in dimensional stability, compared to the current commercial belting. The test belts were less prone to bagging and wrinkling (belt deformation), had improved anchorage and adhesion to the underlying substrate, and were less prone to slippage. The test belts according to this invention were also easier to add to the process equipment, and more flexibility prevented wrinkling during installation of belt on machine. An example test belt is shown in FIGS. 8-11 after use.

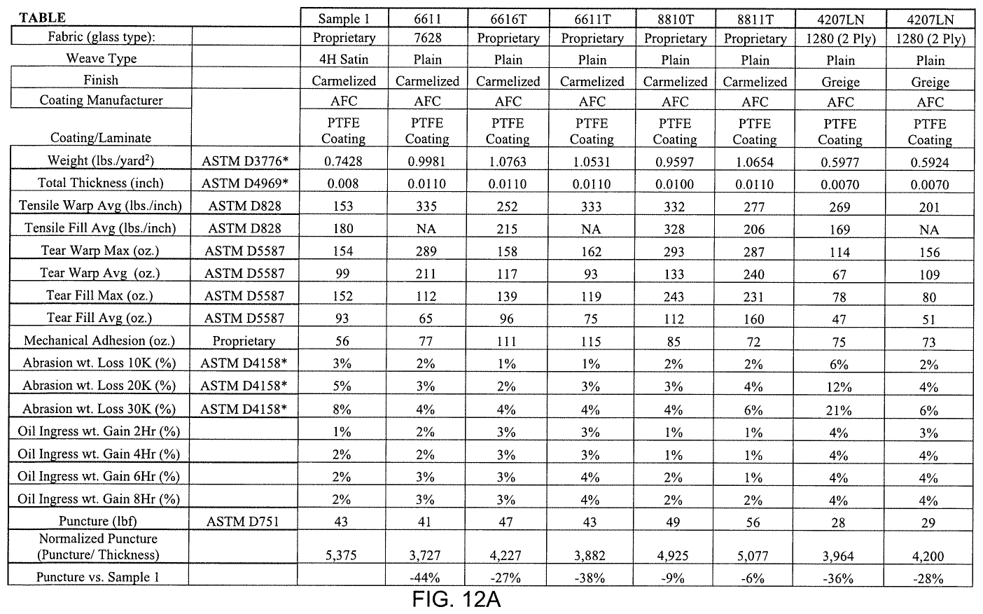

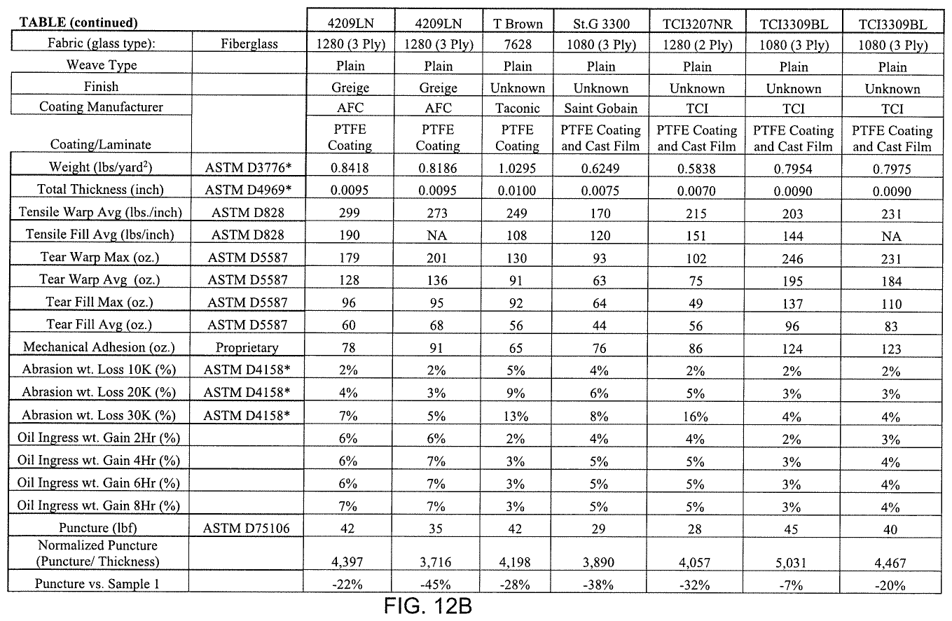

FIGS. 12A-B show results of several tests comparing a material of the present invention, namely an 8 mil PTFE coated 4 harness satin fiberglass substrate (Sample 1), with plain weave materials by Applicant (AFC) and other industry-recognized premium commercial offerings from other manufacturers. The control AFC materials represent Applicant's current offerings to the tortilla manufacturers. As can be seen, the sample material of this invention provides many benefits, but particularly shows significant puncture resistance improvement over the other materials. In use testing shows even better puncture resistance performance than the static lab results of FIGS. 12A-B.

Thus, the invention provides improved belts and belt materials for use in thin, non-stick belt applications.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

1-40. (canceled)

41. A flexible nonstick material for use in press operations, comprising a nonstick polymer coated flexible substrate having a thickness of 15 mils or less, wherein the flexible substrate comprises a woven yarn fabric having a conformable weave.

42. The flexible nonstick material of claim 41, wherein the woven yarn fabric comprises a basket weave or a satin weave

43. The flexible nonstick material of claim 41, wherein the woven yarn fabric comprises yarns of fiberglass and/or a polymer material selected from aramid, polyimide, polyphenylene sulfide, polyethersulfone, polyetheretherketone, or combinations thereof.

44. The flexible nonstick material of claim 41, wherein the woven yarn fabric includes two or more warp fibers alternately interlaced with two or more weft fibers.

45. The flexible nonstick material of claim 41, wherein the woven yarn fabric includes fibers extending in one direction over at least three of a plurality of fibers extending in a second direction before passing under one of the plurality of fibers extending in the second direction.

46. The flexible nonstick material of claim 41, wherein the woven yarn fabric comprises at least a 2×2 basket weave.

47. The flexible nonstick material of claim 41, wherein the woven yarn fabric comprises 4 to 8 harness satin weave.

48. The flexible nonstick material of claim 47, further comprising a thicker polymer coating on a rough side of the 4 to 8 harness satin weave than on a smooth side.

49. The flexible nonstick material of claim 41, further comprising a nonstick polymer coating of a fluoropolymer, a fluoroplastic, a fluoroelastomer, a silicone rubber, a thermoplastic having a heat resistance over 350° F. (177° C.), or combinations thereof.

50. The flexible nonstick material of claim 41, wherein the material is a continuous conveyor belt or a tensioned press platen.

51. The flexible nonstick material of claim 41, wherein the press operations are selected from food pressing or plastic welding, and the flexible nonstick material supports an object to be pressed.

52. A flexible belt, comprising a nonstick polymer coated flexible substrate having a thickness of 15 mils or less, wherein the flexible substrate comprises a woven yarn fabric comprising at least a 2×2 basket weave or a 4 to 8 harness satin weave.

53. The flexible belt of claim 52, wherein the woven yarn fabric comprises yarns of fiberglass and/or a polymer material selected from aramid, polyimide, polyphenylene sulfide, polyethersulfone, polyetheretherketone, or combinations thereof, and further comprising:
a nonstick polymer coating of a fluoropolymer, a fluoroplastic, a fluoroelastomer, a silicone rubber, a thermoplastic having a heat resistance over 350° F. (177° C.), or combinations thereof.

54. The flexible belt of claim 53, wherein the woven yarn fabric includes two or more warp fibers alternately interlaced with two or more weft fibers.

55. The flexible belt of claim 53, wherein the woven yarn fabric includes fibers extending in one direction over at least three of a plurality of fibers extending in a second direction before passing under one of the plurality of fibers extending in the second direction.

56. The flexible belt of claim 53, wherein the woven yarn fabric comprises at least a 2×2 basket weave.

57. The flexible belt of claim 53, wherein the woven yarn fabric comprises 4 to 8 harness satin weave.

58. The flexible belt of claim 57, further comprising a thicker polymer coating on a rough side of the 4 to 8 harness satin weave than on a smooth side.

59. The flexible belt of claim 52, wherein the belt is a continuous conveyor belt or a tensioned press platen.

60. A method of using the flexible belt of claim 52, comprising:
providing the flexible belt under a press platen;
providing an object to be pressed on the flexible belt and under the press platen; and
pressing the object on the flexible belt with the press platen.
